(19) United States
(12) Patent Application Publication
(10) Pub. No.: US 2010/0174760 A1
(43) Pub. Date: Jul. 8, 2010

(54) Tracking Multi-Session Meeting Statuses

(75) Inventors: Giuseppe Longobardi, C/mare di Stabia(NA) (IT); Scot MacLellan, Rome (IT); Luigi Pichetti, Rome (IT)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/348,353

(22) Filed: Jan. 5, 2009

(51) Int. Cl. G06F 17/30; G06F 7/00

(52) U.S. Cl. 707/807; 707/E17.032

(57) ABSTRACT

A mechanism for tracking statuses for multi-session meetings is provided. A list of meetings is received for the multi-session meetings from a moderator of the multi-session meetings. The list of meetings is loaded onto a shared storage device that is accessible by a plurality of participants. Responsive to the status of one meeting in the list of meetings changing, the change to the one meeting in the list of meetings is updated on the shared storage device. Responsive to the change to the one meeting in the list of meetings requiring a change in status to one or more other meetings in the list of meetings, the status of the one or more other meetings is changed.

### BACKGROUND

The present application relates generally to an improved data processing apparatus and method and more specifically to an apparatus and method for tracking multi-session meeting statuses.

Working in teams is a key factor in modern organizations. For this purpose, several possibilities are available to implement collaborative working sessions among multiple participants. A typical meeting consists of participants meeting in a meeting room to discuss a topic of common interest. More sophisticated solutions allow for obtaining the same result without having the participants to meet physically (thereby cutting travel costs). For example, this is possible with a conference call, wherein each of the participants may speak over the telephone so as to be heard by all the other participants.

In cases where a meeting splits into different sessions with different participants for each session, it may be difficult to lead it effectively and to share the meeting statuses with all the participants. In cases where there is a delay, it may be difficult to keep all the participants informed. Usually real-time means like chat or phone calls are used to let each of the participants know when it is their time to come to the meeting; however, this manual approach is time consuming and not practical in case of a large number of participants, especially when successive meetings are planned. In any other case, when informing may not be possible, participants may encounter a loss of productivity by physically going to the meeting room where the meeting is to be held, wait some time, returning to their work and repeating this process over and over until it is the participant's time to actually be part of the meeting. The situation may even worsen when the meeting is in a remote location and some of the participants are to be connected through the phone. These participants may have to dial in several times or wait online. The problem to keep multi-session meeting participants informed has some explicit/hidden costs associated: the time spent by the people going back and forth from the meeting facility, the cost of the wasted time of the calls spent waiting, the time spent in the meeting waiting for the participants to show up, or the like.

### SUMMARY

In one illustrative embodiment, a method, in a data processing system, is provided for tracking statuses for multi-session meetings. The illustrative embodiment receives a list of meetings for the multi-session meetings from a moderator of the multi-session meetings. The illustrative embodiment loads the list of meetings onto a shared storage device that is accessible by a plurality of participants. The illustrative embodiment determines if a change has been made to a status of one meeting in the list of meetings by the moderator. The illustrative embodiment updates the change to the one meeting in the list of meetings on the shared storage device in response to the status of the one meeting being changed. The illustrative embodiment determines if the change to the one meeting in the list of meetings requires a change in status to one or more other meetings in the list of meetings. The illustrative embodiment changes the status of the one or more other meetings in response to the change to the one meeting in the list of meetings requiring a change in status to the one or more other meetings in the list of meetings.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 depicts a block diagram of an application in accordance with a preferred embodiment of the present invention;

FIGS. 4A-4C depict a functional block diagram illustrating a multi-session meeting status tracking mechanism in accordance with an illustrative embodiment; and

FIG. 5 depicts the operation of a multi-session meeting tracking mechanism in accordance with an illustrative embodiment.

### DETAILED DESCRIPTION

The illustrative embodiments provide a mechanism for tracking multi-session meeting statuses. A moderator or attendant schedules a list of meetings or appointments that are to be held in succession. The list of meetings or appointments may be stored in a format that may be viewed by a plurality of participants via a user interface. Each of the meetings or appointments have descriptors that allow each of a plurality of participants an ability to identify one or more meetings or appointments that the participant is scheduled to attend. The descriptors also indicate an original scheduled time for the meeting or appointment and a current status of the meeting or appointment. The status of a current meeting or appointment may be updated by the moderator or attendant as each meeting or appointment in the list of meetings or appointments proceeds. As the status of the current meeting or appointment is updated, each successive meeting or appointment may be automatically updated. Thus, each participant may readily identify the status of the participant's meeting and plan accordingly as to whether the participant should leave early for a meeting or appointment that is ahead of schedule, wait to leave because the meeting or appointment has been delayed, or reschedule the meeting or appointment because the planned meeting or appointment has been cancelled or skipped.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The illustrative embodiments provide for tracking multi-session meeting statuses. While the illustrative embodiments are described in terms of meetings being held to discuss business plans, project statuses, brainstorming, or the like, the illustrative embodiments are not limited to only business meetings. That is, one of ordinary skill in the art would recognize that the illustrative embodiment may be used with any type of meeting or appointment, such as doctor's appointments, performance reviews, parent/teacher conferences, or the like. A moderator posts a list of successive meetings and updates the list of meetings in real time. The list of meetings may be exported and saved in a format that allows the list of meetings to be accessed by a plurality of participants via an interface. The moderator may provide statuses such as ongoing, ending in a few minutes, waiting, delayed, done, rescheduled, or the like. The participants are then able to check how the meeting is evolving and may get an automatic indication, in case of a delay or anticipation, of how their schedule has been affected.

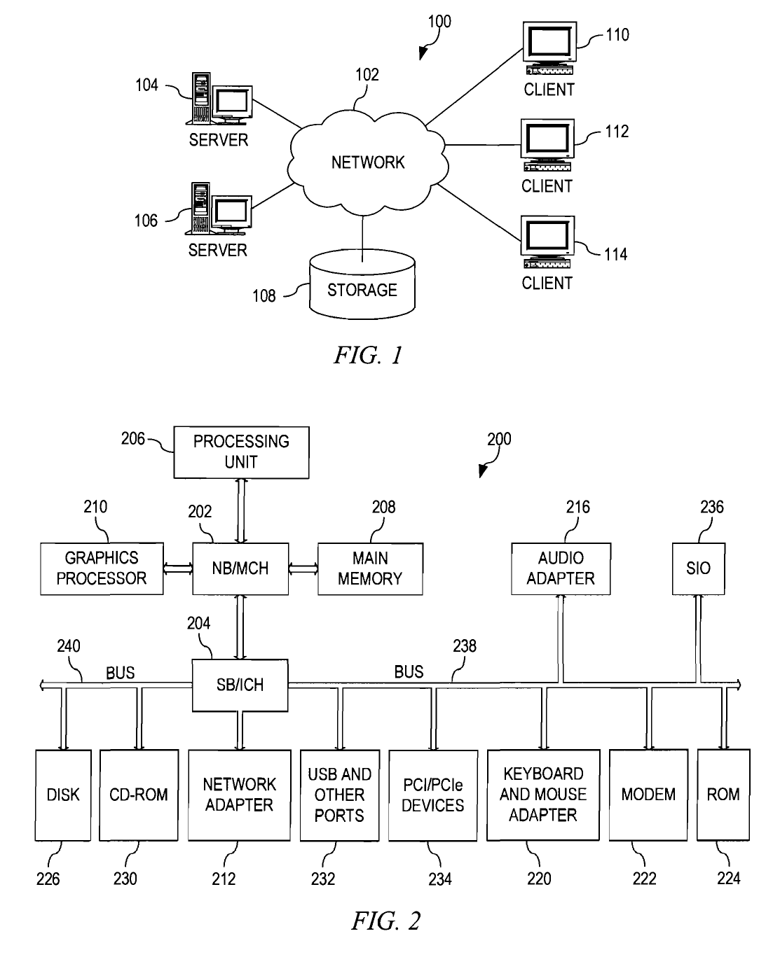

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of a multi-session meeting statuses tracking mechanism, this is only an example and is not intended to state or imply any limitation with regard to the features of the present invention. To the contrary, the illustrative embodiments are intended to include distributed data processing environments and embodiments in which multi-session meeting statuses may be tracked in order to provide the latest information to a plurality if participants.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

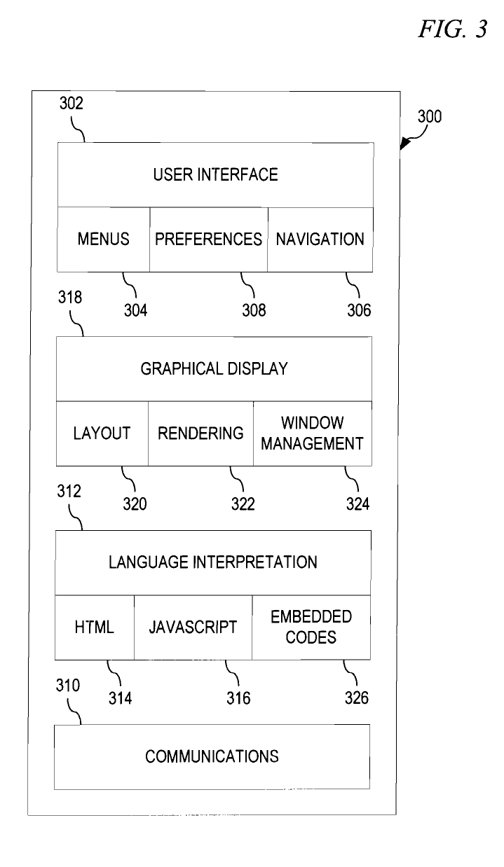

Turning next to FIG. 3, a block diagram of an application is depicted in accordance with a preferred embodiment of the present invention. An application may be any application that is used to navigate or view information or data in a distributed database.

In this example, application 300 includes a user interface 302, which may be a graphical user interface (GUI) that allows the user to interface or communicate with application 300. User interface 302 provides for selection of various functions through menus 304 and allows for navigation through navigation 306. For example, menu 304 may allow a user to perform various functions, such as saving a file, opening a new window, displaying a history, and entering a URL. Navigation 306 allows for a user to navigate various pages and to select web sites for viewing. For example, navigation 306 may allow a user to see a previous page or a subsequent page relative to the present page. Preferences such as those illustrated in FIG. 3 may be set through preferences 308.

Communications 310 is the mechanism with which application 300 receives documents and other resources from a network, such as the Internet, Intranet, or other network server. Further, communications 310 is used to send or upload documents and resources onto a network. In the depicted example, communications 310 uses HTTP; however, other protocols may be used depending on the implementation. Documents that are received by application 300 are processed by language interpretation 312, which includes HTML unit 314, JavaScript™ unit 316, and embedded codes 326. Language interpretation 312 will process a document for presentation on graphical display 318. In particular, HTML statements are processed by HTML unit 314 for presentation while JavaScript statements are processed by JavaScript unit 316. Language interpretation 312 may also process codes that are embedded within a document using embedded codes 326. Graphical display 318 includes layout unit 320, rendering unit 322, and window management 324. These units are involved in presenting documents to a user based on results from language interpretation 312.

Application 300 is presented as an example of a program in which the present invention may be embodied. Application 300 is not meant to imply architectural limitations to the present invention. Presently available applications may include additional functions not shown or may omit functions shown in application 300.

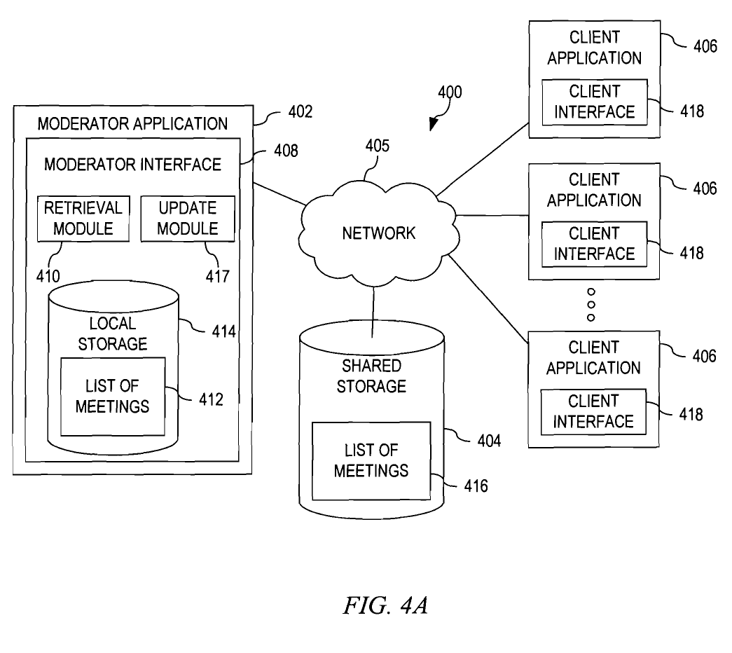

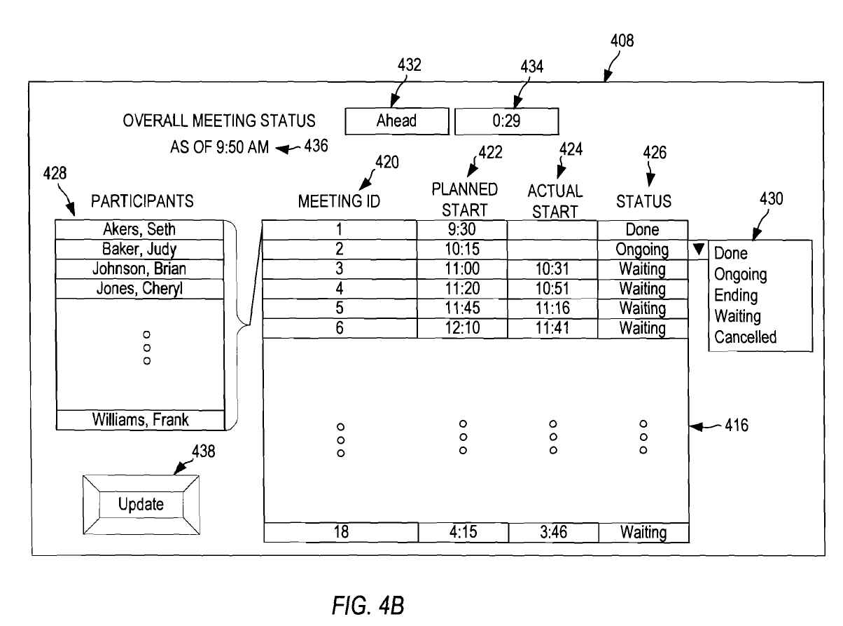

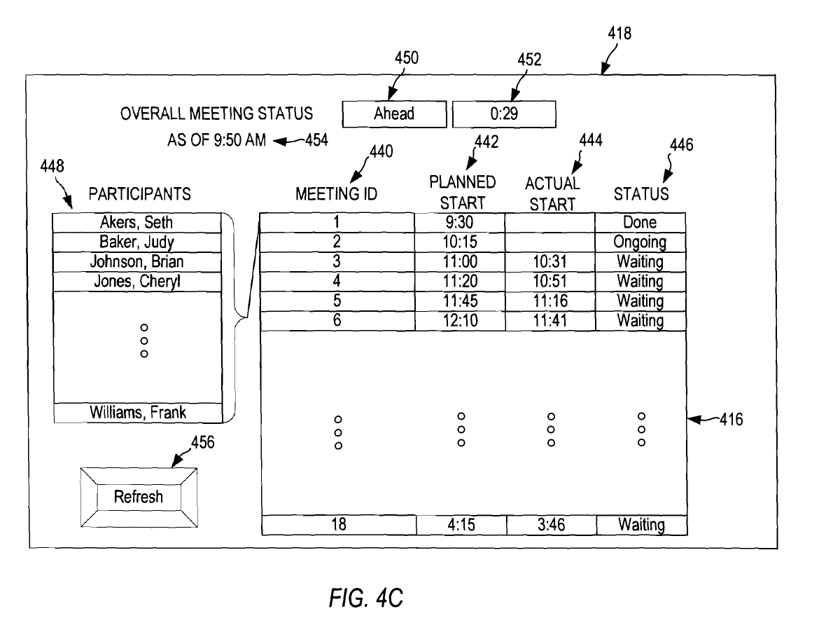

FIGS. 4A-4C depict a functional block diagram illustrating a multi-session meeting status tracking mechanism in accordance with an illustrative embodiment. In FIG. 4A, multi-session meeting status tracking mechanism 400 comprises moderator application 402, shared storage 404, and a plurality of client applications 406, all of which may be connected via network 405. Moderator application 402 comprises moderator interface 408 from which a moderator may either directly create or update list of meetings 416, using update module 417, that will be held in succession, or retrieve, using retrieval module 410, a previously created list of meetings 412 that will be held in succession from local storage 414 and uploaded to list of meetings 416 in shared storage 404. Moderator interface 408 may be an interface to a Web-based formatting application, an interface to a spreadsheet application, or any other type of application that is capable of storing and manipulating information. Moderator interface 408 or retrieval module 410 may then store list of meetings 416 on shared storage 404. Client interface 418 on each of client applications 406 is then able to access and display list of meetings 416 to a plurality of participants.

As is shown in FIG. 4B, moderator interface 408 may comprise a number of descriptors as well as other information that is pertinent to the multi-session meetings. The descriptors of moderator interface 408 may comprise meeting identifier 420, planned start time 422, actual start time 424, and status 426 for each of the meetings in list of meetings 416. Additionally, the moderator may associate one or more participants to each meeting in list of meetings 416 which will be displayed in list of participants 428. As the meetings in list of meetings 416 proceed, the moderator is able to update a status associated with the meeting by selecting a status from status list 430 that is associated with the status field. Status list 430 may be a drop down list of statuses that may comprise predetermined statuses, such as Done, Ongoing, Waiting, Canceled, Ending, or the like. In one embodiment, once the moderator selects the Done status associated with one meeting, then the next successive meeting status may be automatically changed by update module 417 to Ongoing. In another embodiment, after the moderator selects the Done status associated with one meeting, then the moderator may be required to manually change the status of the next successive meeting to Ongoing.

In either case, once the status of the next successive meeting is changed to Ongoing, then an overall meeting status descriptor 432 is automatically updated by update module 417 to reflect a current overall meeting status, by indicating Ahead, Delayed, On Track, or the like. If overall meeting status descriptor 432 indicates that the overall meeting status is Ahead, then time field 434 may indicate the amount of time the overall meeting is ahead of schedule. If overall meeting status descriptor 432 indicates that the overall meeting status is Delayed, then time field 434 may indicated the amount of time the overall meeting is behind schedule. If overall meeting status descriptor 432 indicates that the overall meeting status is On Track, i.e. not Ahead or Delayed, then time field 434 may be blank. Additionally, as the moderator updates fields within moderator interface 408, overall meeting status descriptor 432 may include time stamp 436 which indicates the last time the moderator changed a field in moderator interface 408. In one illustrative embodiment, each time the moderator changes a field then update module 417 automatically updates the associated information on shared storage 404. In another illustrative embodiment, the moderator may be equipped with update button 438 so that, only after the moderator makes all necessary changes and selects update button 438, does update module 417 update the information on shared storage 404.

Similar to moderator interface 408 is client interface 418 of client application 406, as is shown in FIG. 4C. Client interface 418 may be an interface to a Web-based formatting application, an interface to a spreadsheet application, or any other type of application that is capable of access and displaying information. In client interface 418, a participant is provided with a number of descriptors as well as other information that is pertinent to the multi-session meetings. The descriptors of client interface 418 may comprise meeting identifier 440, planned start time 442, actual start time 444, and status 446 for each of the meetings in list of meetings 416. Additionally, the participant is provided with list of participants 448 that displays the participants associated with each meeting and changes as the participant selects one of the meetings in list of meetings 416. The participant is also provided with overall meeting status descriptor 450 that reflects a current overall meeting status and time field 452 that indicates the amount of time the overall meetings are either ahead or behind schedule. Additionally, the participant is provided with time stamp 454 that indicates the last time the moderator updated list of meetings 416. Client interface 418 may be an automatically refreshed interface which refreshes at predetermined intervals or client interface 418 may be a manually refreshed interface, in which case the participant is provided with refresh button 456 so that only when the participant selects refresh button 456 is the information in client interface 418 refreshed.

Thus, the illustrative embodiments provide a mechanism for tracking multi-session meeting statuses. The moderator schedules a list of meetings that are to be held in succession. The list of meetings may be stored in a format that may be viewed by a plurality of participants via a user interface. Each of the meetings has descriptors that allow each of a plurality of participants an ability to identify one or more meetings that the participant is scheduled to attend. The descriptors also indicate an original scheduled time for the meeting and a current status of the meeting. The status of a current meeting may be updated by the moderator as each meeting in the list of meetings proceeds. As the status of the current meeting is updated, each successive meeting or appointment may be automatically updated. Thus, each participant may readily identify the status of the participant's meeting and plan accordingly as to whether the participant should leave early for a meeting that is ahead of schedule, wait to leave because the meeting has been delayed, or reschedule the meeting because the planned meeting has been cancelled.

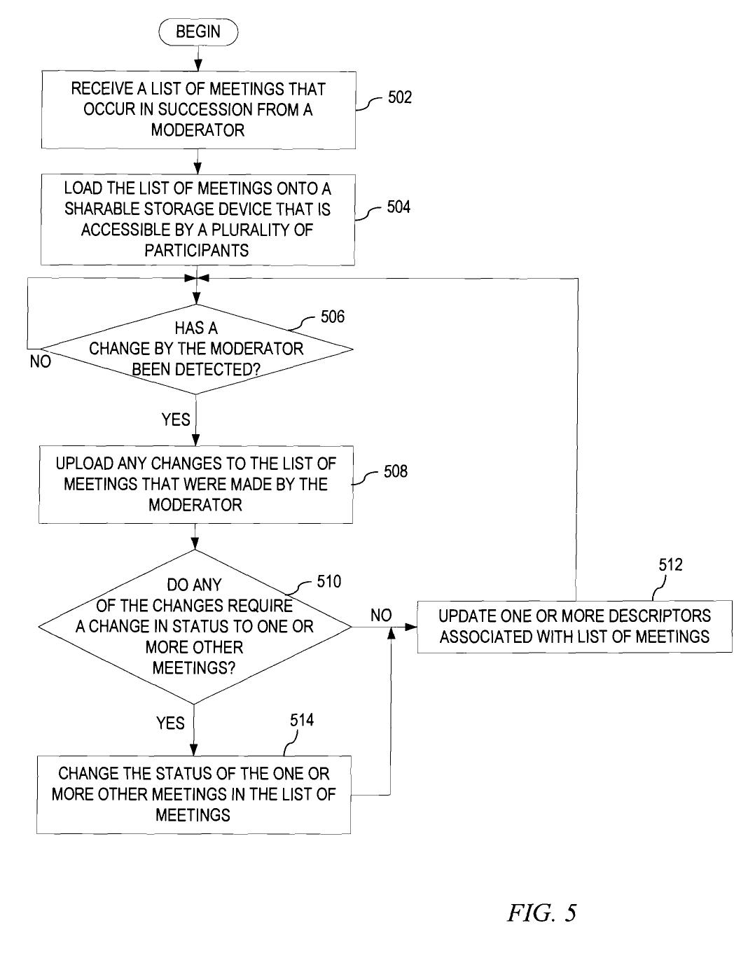

FIG. 5 depicts the operation of a multi-session meeting tracking mechanism in accordance with an illustrative embodiment. As the operation begins, the multi-session meeting tracking receives a list of meetings that occur in succession from a moderator (step 502). The list may be directly input from an input device such as a keyboard, mouse, or the like, or may be loaded from a local storage device. The multi-session meeting tracking mechanism loads the list of meetings onto a sharable storage device that is accessible by a plurality of participants (step 504). As each meeting in the list of meetings progresses, the moderator may update a status associated with a meeting in the list of meetings that occur in succession. Thus, the multi-session meeting tracking mechanism determines if a change has been detected (step 506). Based on a predetermined set of rules, the multi-session meeting tracking mechanism may upload changes to the list of meetings as each change is made or based on an indication from the moderator that all of the changes should be uploaded at a single time.

If at step 506 the multi-session meeting tracking mechanism has not detected that any changes should be uploaded to the list of meetings on the shared storage device, then the operation returns to step 506. If at step 506 the multi-session meeting tracking mechanism detects that a change should be made to the list of meetings on the shared storage device, then the multi-session meeting tracking mechanism uploads any changes to the list of meetings that were made by the moderator (step 508). At that time of uploading the changes to the list of meetings, the multi-session meeting tracking mechanism may also determine if the changes to the status of the meeting in the list of meetings requires a change in the status of one or more other meetings in the list of meetings (step 510). If at step 510 the multi-session meeting tracking mechanism determines that the uploaded changes do not change the status of one or more other meetings in the list of meetings, then the multi-session meeting tracking mechanism updates one or more descriptors associated with the list of meetings (step 512), with the operation returning to step 506 thereafter. The one or more descriptors may comprise an actual start time, an overall meeting status, a time field associated with the overall meeting status, a time stamp that indicates the time at which the last update was performed, or the like.

If at step 510 the multi-session meeting tracking mechanism determines that the uploaded changes require a change in status of one or more other meetings in the list of meetings, then, if the predetermined set of rules allow for an automatic update of the status of the one or more other meetings, the multi-session meeting tracking mechanism changes the status of the one or more other meetings in the list of meetings (step 514) and updates one or more descriptors associated with the list of meetings (step 512). Once the multi-session meeting tracking mechanism updates the one or more descriptors, then the operation returns to step 506. Thus, the participants are able to access the list of meetings using a client interface in order to check how their meeting(s) is evolving and may get an automatic indication, in case of a delay or anticipation, of how their schedule is affected.

Thus, the illustrative embodiments provide for tracking multi-session meeting statuses. While the illustrative embodiments are described in terms of meetings being held to discuss business plans, project statuses, brainstorming, or the like, the illustrative embodiments are not limited to only business meetings. That is, one of ordinary skill in the art would recognize that the illustrative embodiment may be used with any type of meeting or appointment, such as doctor's appointments, performance reviews, parent/teacher conferences, or the like. A moderator posts a list of successive meetings and updates the list of meetings in real time. The list of meetings may be exported and saved in a format that allows the list of meetings to be accessed by a plurality of participants via an interface. The moderator may provide statuses such as ongoing, ending in a few minutes, waiting, delayed, done, rescheduled, or the like. The participants are then able to check how the meeting is evolving and may get an automatic indication, in case of a delay or anticipation, of how their schedule has been affected.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for tracking statuses for multi-session meetings, the method comprising:
receiving a list of meetings for the multi-session meetings from a moderator of the multi-session meetings;
loading the list of meetings onto a shared storage device that is accessible by a plurality of participants;
determining if a change has been made to a status of one meeting in the list of meetings by the moderator;
responsive to the status of the one meeting being changed, updating the change to the one meeting in the list of meetings on the shared storage device;
determining if the change to the one meeting in the list of meetings requires a change in status to one or more other meetings in the list of meetings; and
responsive to the change to the one meeting in the list of meetings requiring a change in status to the one or more other meetings in the list of meetings, changing the status of the one or more other meetings.

2. The method of claim 1, wherein updating the change to the one meeting in the list of meetings on the storage device is performed in response to the moderator indicating that the change is to be performed.

3. The method of claim 1, wherein updating the change to the one meeting in the list of meetings on the storage device is performed automatically upon the change to the one meeting in the list of meetings being detected.

4. The method of claim 1, further comprising:
responsive to the status of the one meeting being changed, updating one or more descriptors associated with the one meeting in the list of meetings.

5. The method of claim 4, wherein the one or more descriptors comprise at least one of an actual start time, an overall meeting status, a time field associated with the overall meeting status, or a time stamp that indicates the time at which the last update was performed.

6. The method of claim 1, further comprising:
responsive to the change to the one meeting in the list of meetings requiring a change in status to the one or more other meetings in the list of meetings, updating one or more descriptors associated with the one or more other meetings in the list of meetings.

7. The method of claim 6, wherein the one or more descriptors comprise at least one of an actual start time, an overall meeting status, a time field associated with the overall meeting status, or a time stamp that indicates the time at which the last update was performed.

8. A computer program product comprising a computer recordable medium having a computer readable program recorded thereon, wherein the computer readable program, when executed on a computing device, causes the computing device to:
receive a list of meetings for the multi-session meetings from a moderator of the multi-session meetings;
load the list of meetings onto a shared storage device that is accessible by a plurality of participants;
determine if a change has been made to a status of one meeting in the list of meetings by the moderator;
responsive to the status of the one meeting being changed, update the change to the one meeting in the list of meetings on the shared storage device;
determine if the change to the one meeting in the list of meetings requires a change in status to one or more other meetings in the list of meetings; and
responsive to the change to the one meeting in the list of meetings requiring a change in status to the one or more other meetings in the list of meetings, change the status of the one or more other meetings.

9. The computer program product of claim 8, wherein the computer readable program to update the change to the one meeting in the list of meetings on the storage device is performed by the computing device in response to the moderator indicating that the change is to be performed.

10. The computer program product of claim 8, wherein the computer readable program to update the change to the one meeting in the list of meetings on the storage device is performed by the computing device automatically upon the change to the one meeting in the list of meetings being detected.

11. The computer program product of claim 8, wherein the computer readable program further causes the computing device to:
responsive to the status of the one meeting being changed, update one or more descriptors associated with the one meeting in the list of meetings.

12. The computer program product of claim 11, wherein the one or more descriptors comprise at least one of an actual start time, an overall meeting status, a time field associated with the overall meeting status, or a time stamp that indicates the time at which the last update was performed.

13. The computer program product of claim 8, wherein the computer readable program further causes the computing device to:
responsive to the change to the one meeting in the list of meetings requiring a change in status to the one or more other meetings in the list of meetings, update one or more descriptors associated with the one or more other meetings in the list of meetings.

14. The computer program product of claim 13, wherein the one or more descriptors comprise at least one of an actual start time, an overall meeting status, a time field associated with the overall meeting status, or a time stamp that indicates the time at which the last update was performed.

15. An apparatus, comprising:
a processor; and
a memory coupled to the processor, wherein the memory comprises instructions which, when executed by the processor, cause the processor to:
receive a list of meetings for the multi-session meetings from a moderator of the multi-session meetings;
load the list of meetings onto a shared storage device that is accessible by a plurality of participants;
determine if a change has been made to a status of one meeting in the list of meetings by the moderator;
responsive to the status of the one meeting being changed, update the change to the one meeting in the list of meetings on the shared storage device;
determine if the change to the one meeting in the list of meetings requires a change in status to one or more other meetings in the list of meetings; and
responsive to the change to the one meeting in the list of meetings requiring a change in status to the one or more other meetings in the list of meetings, change the status of the one or more other meetings.

16. The apparatus of claim 15, wherein the instructions to update the change to the one meeting in the list of meetings on the storage device is performed by the processor in response to the moderator indicating that the change is to be performed.

17. The apparatus of claim 15, wherein the instructions to update the change to the one meeting in the list of meetings on the storage device is performed by the processor automatically upon the change to the one meeting in the list of meetings being detected.

18. The apparatus of claim 15, wherein the instructions further cause the processor to:
responsive to the status of the one meeting being changed, update one or more descriptors associated with the one meeting in the list of meetings.

19. The apparatus of claim 18, wherein the one or more descriptors comprise at least one of an actual start time, an overall meeting status, a time field associated with the overall meeting status, or a time stamp that indicates the time at which the last update was performed.

20. The apparatus of claim 15, wherein the instructions further cause the processor to:
responsive to the change to the one meeting in the list of meetings requiring a change in status to the one or more other meetings in the list of meetings, update one or more descriptors associated with the one or more other meetings in the list of meetings, wherein the one or more descriptors comprise at least one of an actual start time, an overall meeting status, a time field associated with the overall meeting status, or a time stamp that indicates the time at which the last update was performed.
